(19) United States
(12) Patent Application Publication
(10) Pub. No.: US 2026/0159531 A1
(43) Pub. Date: Jun. 11, 2026

(54) What is next? Calmexia

(71) Applicant: Ashley Princess Castillo, Smithtown, NY (US)

(72) Inventor: Ashley Princess Castillo, Smithtown, NY (US)

(73) Assignee: Ashley Princess Castillo, Smithtown, NY (US)

(21) Appl. No.: 18/831,625

(22) Filed: Jun. 23, 2025

(51) Int. Cl. C07F 3/02

(52) U.S. Cl. CPC C07F 3/02

(57) ABSTRACT

Calmixea, It levels highs and lows of Bipolar 1. It also raises lows of Bipolar 2. Calmixea relieves all types of Anxiety. It also treats Depression, making it dissipate. Calmixea levels symptoms of Bipolar 1 & 2, Anxiety and Depression. Calmixea is an reuptake inhibitor of Serotonin, Dopamine, GABA (Gamma Aminobutyric Acid). All neurotransmitters. Parietal lobe: touch, taste, temperature. Temporal lobe: auditory information, comprehension, and language. Occipital lobe: visual information. Olfactory: directs information from the bulb to other areas of the brain. Thalamus: relay station. With Calmixea all 5 senses are reached, therefore heightened. Amygdala is the first processor of the olfactory function. Thalamus processes all functions. Calmixea is directly inhaled; IT will remind you of better days and will restore needed peace . . .

Calmixea is a formula that helps the symptoms Bipolar 1 and 2, Anxiety and Depression. Calmixea is a Serotonin, Dopamine and Gaba (Gama-aminobutyric acid) reuptake inhibitor. Which are neurotransmitters. What Calmixea makes you feel happy, euphoric, helps you in mood and sleep. Calmixea clears your thoughts, and cognition, gives you pleasure and motivates you. Clearing anxiety and removes the sense of panic. Psychiatric medications don't address symptoms, only address levels to maintain patients out of the hospital. Calmixea can be added to any arrangement of medications to help patients to feel calm and relaxed.

Calmixea is a formula that helps the symptoms Bipolar 1 and 2, Anxiety and Depression. Calmixea is a Serotonin, Dopamine and Gaba (Gama-aminobutyric acid) reuptake inhibitor. Which are neurotransmitters. What Calmixea makes you feel happy, euphoric, helps you in mood and sleep. Calmixea clears your thoughts, and cognition, gives you pleasure and motivates you. Clearing anxiety and removes the sense of panic. Psychiatric medications don't address symptoms, only address levels to maintain patients out of the hospital. Calmixea can be added to any arrangement of medications to help patients to feel calm and relaxed.

1. (canceled)

2. Calmixea is a Serotonin Reuptake Inhibitor

3. (canceled)

4. In individuals with depression, improvements in happiness are dependent on SSRIs treatment through increased serotonin availability

5. (canceled)

6. The enhancement of good mood among individuals with depressive symptoms is dependent on SSRIs treatment, which increases synaptic serotonin availability and subsequently regulates mood related neuronal pathways.

7. (canceled)

8. Improvement in sleep quality is dependent on the use of Selective Serotonin Reuptake Inhibitors SSRIs through their regulation of serotonin levels in the brain.

9. (canceled)

10. SSRIs reduce memory impairment with age related cognitive decline.

11. SSRIs improve mind working capacity, therefore improving environmental recall ability and/or specificity to detail.

12. (canceled)

13. (canceled)

14. Calmixea is a Dopamine Reuptake Inhibitor

15. (canceled)

16. (canceled)

17. In Dopamine Reuptake Inhibitors Elated effect observed after 30 minutes of administration and euphoric effect in human subjects.

18. (canceled)

19. As a result of the increased dopamine, dopamine reuptake inhibitors can produce subjective feelings of pleasure and reward.

20. (canceled)

21. Increase in locomotor activity, voluntary movement, or motivated behavior in Dopamine Reuptake inhibitors.

22. (canceled)

23. Dopamine Reuptake Inhibitor increase in dopaminergic neurotransmission associated with subject pleasure.

24. Arousal motivation, behavioral activation producing minimal excitation in the absence of outcome related stimuli in Dopamine Reuptake inhibitors

25. (canceled)

26. Improves mental function selected from the group consisting of attention, working memory and executive control in Dopamine reuptake inhibitors

27. A dopamine reuptake inhibitor in presentation selectively enhances tasks contingent upon the presentation of rewarding outcome, such that learning is facilitated when subject experiences positive reinforcement, and is minimally affected in the absence of reward feedback.

28. (canceled)

30. (canceled)

29. Calmixea is a GABA (gamma-aminobutyric-acid) Reuptake Inhibitor

31. (canceled)

32. GABA Reuptake Inhibitor increases activity therefore enhances and promotes relaxation.

33. (canceled)

34. GABA Reuptake Inhibitor increases GABAergic signaling to promote initiation or maintenance of sleep.

35. (canceled)

36. GABA Reuptake Inhibitor decreases panic attacks, intensity and duration in the subject.

37. (canceled)

38. GABA Reuptake Inhibitor increases subjective relaxation or calmness relative to baseline.

39. (canceled)

40. GABA Reuptake Inhibitor reduces central nervous system hyperexcitability.

41. (canceled)

42. GABA Reuptake Inhibitor reduces hyperexcitability associated with epilepsy.

43. GABA Reuptake Inhibitor reduces hyperexcitability associated with insomnia.
